(19) United States
(12) Patent Application Publication
(10) Pub. No.: US 2026/0206013 A1
(43) Pub. Date: Jul. 16, 2026

(54) SHARED UTILIZATION OF USER EQUIPMENT CAPABILITY

(71) Applicant: ZTE CORPORATION, Shenzhen, Guangdong (CN)

(72) Inventors: Jing SHI, Shenzhen (CN); Xianghui HAN, Shenzhen (CN); Shuaihua KOU, Shenzhen (CN); Xingguang WEI, Shenzhen (CN)

(21) Appl. No.: 19/137,060

(22) PCT Filed: May 5, 2023
(86) PCT No.: PCT/CN2023/092299

§ 371 Date: Jun. 9, 2025

(51) Int. Cl. H04W 72/0453; H04L 5/14; H04W 72/21; H04W 72/231; H04W 72/51

(52) U.S. Cl. CPC H04W 72/0453; H04L 5/14; H04W 72/21; H04W 72/231; H04W 72/51

(57) ABSTRACT

A wireless communications method is provided. The wireless communications method includes: reporting, by a user equipment (UE), a UE capability; and supporting, by the UE, a function sharing based on the reported UE capability, wherein the function sharing is supported within one or more carriers, cells, or bands.

### CROSS-REFERENCE TO RELATED APPLICATION(S)

This application is a national phase entry under 35 USC 371 of International Patent Application No. PCT/CN2023/092299 filed on May 5, 2023, and the entire content of the International Patent Application is incorporated into this application by reference.

### TECHNICAL FIELD

This document is directed generally to wireless communications. More specifically, in a mobile device communications system, there may be sharing of user equipment (UE) capability.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfill the requirements from different industries and users. User mobile stations or user equipment (UE) are becoming more complex and the amount of data communicated continually increases.

### SUMMARY

This document relates to methods, systems, and devices for sharing utilization of user equipment (UE) capability. UE capability may be reported by the UE to the network, the UE capability may be shared within multiple carriers/cells/bands. With Carrier Aggregation (CA), multiple carriers or cells from one or more bands may be configured for capacity improvement. For example, there may be UE capabilities defined per band or per carrier which can be shared among the carriers or bands.

In one embodiment, a method for wireless communication includes reporting, by a user equipment (UE), a UE capability; and supporting, by the UE, a function sharing based on the reported UE capability, wherein the function sharing is supported within multiple carriers, cells, or bands. The function sharing supports at least one antenna for at least two bands. The at least one antenna on one band in a set of bands can be used for another band in the set of bands. The at least one antenna for a set of bands can be used for at least one band of the set of bands. The function sharing supports at least one power amplifier (PA) for at least two bands. When the at least one PA is shared between multiple bands, wherein the at least one PA of the band with a highest capability of the bands is used. The method includes reporting a duration for PA switching combined with transmitter (Tx) switching, wherein the duration is applied for both PA switching and Tx switching, or the duration is an additional duration applied for PA switching. A higher power or a higher power class can be supported by PA sharing or switching for a band within a band pair or band combination. The function sharing supports duplexer enhancement within a single band or within multiple bands. The duplexer enhancement within the single band comprises sharing a duplexer between SBFD and non-SBFD symbols for a carrier with sub-band full duplex (SBFD) supported on the single band. The duplexer enhancement within the multiple bands comprises sharing a duplexer for the duration of the SBFD symbols of the multiple bands, wherein the SBFD symbols on multiple bands are non-overlapped and the sharing is for at least two carriers with SBFD supported on the multiple bands. The function sharing supports a Physical Downlink Control Channel (PDCCH) monitoring capability enhancement within multiple cells, wherein the PDCCH monitoring capability enhancement comprises sharing PDCCH candidates blind decode (BD) or non-overlapped control channel element (CCE). More than one threshold is applied for candidates dropping on primary cell (PCell). One threshold from the more than a first threshold is used in a slot when there is no sharing BD/CCE from other cells, and the second threshold from the more than one threshold is used in a slot when sharing of BD/CCE is applied from other cells. The second threshold is applied when there is no need to monitor PDCCH for at least one SCell. The function sharing supports an uplink (UL) channel processing capability enhancement, wherein at least two Physical Uplink Shared Channel (PUSCH) being overlapped in time domain on a single carrier is supported, or PUSCH and Physical Uplink Control Channel (PUCCH) being overlapped in time domain on a single carrier is supported. The method further includes at least of: providing an indication of frequency hopping for each PUSCH in a Downlink Control Information (DCI); and providing an independent resource block (RB) offset list for the overlapped PUSCH. A transmission scheme is used by a DCI indication, the candidate transmission scheme comprising uplink control information (UCI) multiplexed on PUSCH, or PUCCH and PUSCH transmitted simultaneously.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, and the code, when executed by a processor, causes the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a block diagram of an example configuration of a transceiver and antenna.

FIG. 4 shows a block diagram illustrating relationships between carriers, bands, and cells.

FIG. 5A shows an embodiment of transmitter (Tx) switching without power amplifier (PA) switching.

FIG. 5B shows an embodiment of transmitter (Tx) switching with power amplifier (PA) switching.

FIG. 6 shows an embodiment of sub-band full duplex (SBFD) on two bands.

FIG. 7A shows an embodiment for FDMed Physical Uplink Shared Channel (PUSCH) without frequency hopping.

FIG. 7B shows an embodiment for FDMed PUSCH with frequency hopping.

FIG. 7C shows an embodiment of a slot with more than one overlapped Physical Uplink Shared Channel (PUSCH).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell.

The 4th Generation mobile communication technology (4G) Long-Term Evolution (LTE) or LTE-Advance (LTE-A) and the 5th Generation mobile communication technology (5G) have increased demands. Based on the current development trend, 4G and 5G systems are developing support on features of enhanced mobile broadband (eMBB), ultra-reliable low-latency communication (URLLC), and massive machine-type communication (mMTC). Carrier Aggregation (CA) can be both used in 4G and 5G and future communication systems. Multiple carriers or cells from one or more bands can be configured for capacity improvement with user equipment (UE) capability sharing. UE capabilities are shared within carriers/bands/cells. Uplink (UL) transmission (Tx) switching is an example of a UE capability that is shared between two bands from one transmitter. Allowing the UE capability to be shared improves communications if one carrier or one band is not working at a time or is not working within a period/duration. In another example, if some hardware or software can be shared among bands or carriers, higher UE capability could be achieved for some UE with less cost restriction. UE capability sharing is further described in the embodiments below.

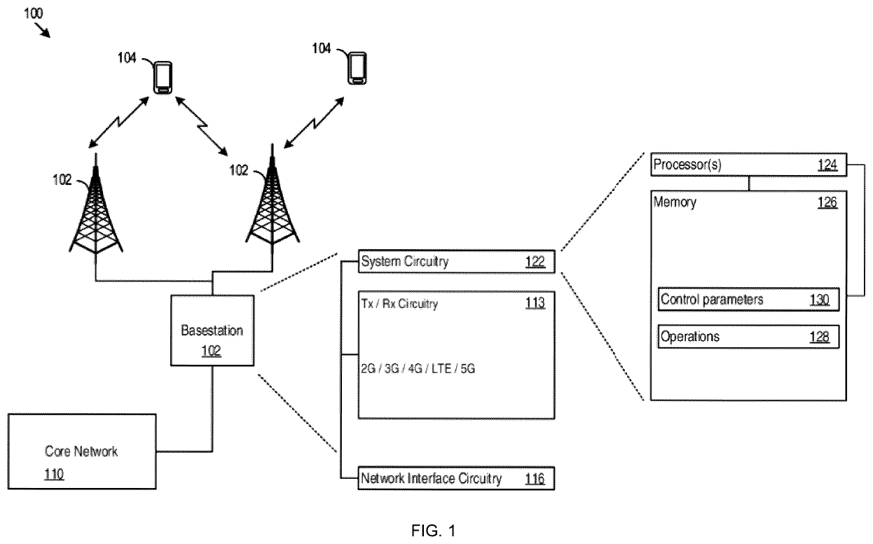

FIG. 1 shows an example basestation 102. The basestation may also be referred to as a network device or wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning of the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals. Also, particular signals can be characterized or defined as either an uplink (UL) signal, a downlink (DL) signal, or a sidelink (SL) signal. An uplink signal is a signal transmitted from a UE 104 to a basestation 102. A downlink signal is a signal transmitted from a basestation 102 to a UE 104. A sidelink signal is a signal transmitted from one UE 104 to another UE 104.

For at least some specifications, such as 5G New Radio (NR), data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of physical channel. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signal received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a basestation 102 to a UE 104. In other embodiments, the control information includes uplink control information (UCI) that is transmitted in the uplink direction from a UE 104 to a basestation 102, or sidelink control information (SCI) that is transmitted in the sidelink direction from one UE 104 to another UE 104.

In addition, in some embodiments, a UE 104 may be configured to support at least one simultaneous UL transmission mode across a band pair for UL transmissions. In a first simultaneous UL transmission mode (also called a switched UL mode), the UE 104 does not support simultaneous UL transmission across a band pair. Accordingly, when the UE 104 transmits a UL transmission in the first simultaneous UL transmission mode, the UE 104 transmits the UL transmission without simultaneously transmitting across a band pair. In addition, in a second simultaneous UL transmission mode (also called a dual UL mode), the UE 104 supports simultaneous UL transmission across a band pair. Accordingly, when the UE 104 transmits a UL transmission in the second simultaneous UL transmission mode, the UE 104 may transmit the UL transmission by simultaneously transmitting across a band pair.

Also, in some embodiments, the UE 104 may report the simultaneous UL transmission mode(s) to the basestation 102. That is, the UE 104 may report, to the basestation 102, that it supports simultaneous UL transmission across a band pair, that it does not support simultaneous UL transmission across a band pair, or that it both supports and does not support simultaneous UL transmission across a band pair. In particular of these embodiments, the UE 104 may report whether or not it supports simultaneous UL transmission across a band pair per band combination (BC). Also, the basestation 102 may be configured the simultaneous UL transmission mode (e.g., switched UL or dual UL) per cell group, which may be considered as per BC or per band pair in embodiments where a 2Tx user device supports only two bands. That is, one available band pair in a band combination may support one simultaneous UL transmission mode.

Additionally, in general as used herein, a band combination may include a plurality of bands (e.g., five bands). In addition, as used herein, a band group may include up to three or four bands. A given band group may be included in or part of a band combination. Also, a band combination and/or a band group may include at least one band pair, where a band pair includes two bands.

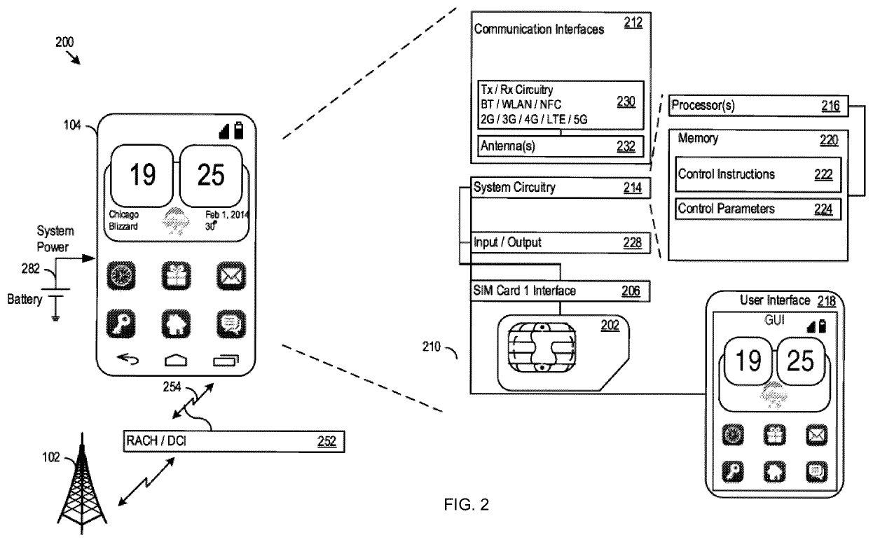

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 (also referred to as SIM card 1 interface) connects SIM1 202 to the rest of the user equipment hardware, for example, through the system bus 210.

The mobile device 200 (UE 104) includes communication interfaces 212, system logic (also referred to as system circuitry) 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the input/output 228 may include a graphical user interface, touch sensitive display, haptic feedback or other haptic output, voice or facial recognition inputs, buttons, switches, speakers and other user interface elements. Additional examples of the input/output 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC.

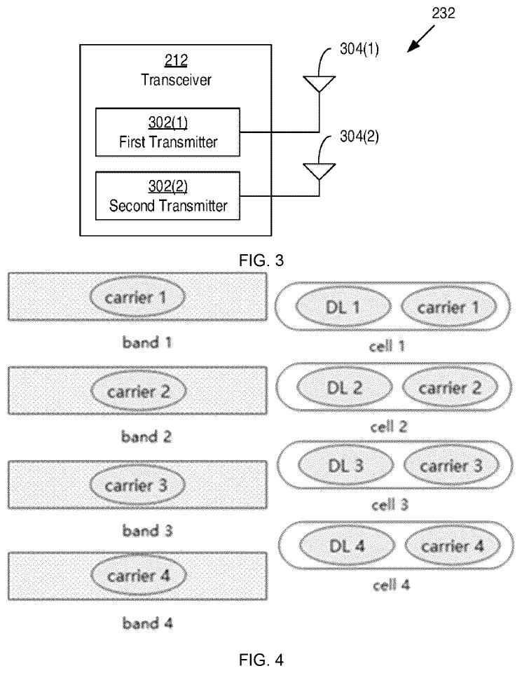

FIG. 3 shows a block diagram of an example configuration of the transceiver 212 and the antenna 232. In particular, the transceiver 212 includes a first transmitter (Tx) (or transmitter circuit) 302(1) and a second transmitter (Tx) (or transmitter circuit) 302(2). In addition, the antenna 232 may include a first antenna component 304(1) and a second antenna component 304(2). In general, the first transmitter 302(1) and the first antenna component 304(1) may form a first transmitter channel or chain, and the second transmitter 302(2) and the second antenna component 304(2) may form a second transmitter channel or chain. A UE 104, with the configuration in FIG. 2, may be configured to transmit a first UL transmission (or a first part of a UL transmission) using the first transmitter channel, and may be configured to transmit a second UL transmission (or a second part of a UL transmission) using the first transmitter channel.

In some embodiments, the UE 104 may use the two transmitter channels to transmit on one or two bands or carriers. The UE 104 may do so in any of various ways. For example, the UE 104 may transmit on a single carrier using both the first Tx and the second Tx. As another example, the UE 104 may transmit on a first carrier using the first Tx and on a second carrier using the second Tx. As used herein, the terms “1 Tx” and “1T” refer to use of one transmitter channel or chain to transmit on one carrier, and the terms “2 Tx” and “2T” refer to the use of two transmitter channels or chains to transmit on one carrier. In addition, as used herein, the phrase “UL transmit case” refers to a particular configuration of the transmit channels used for a UL transmission on one or more carriers. Also, as described in further detail below, the UE 104 may switch between UL transmit cases during a UL Tx switching operation.

In addition, in various embodiments, the UE 104 may perform UL transmitter (Tx) switching to perform UL transmissions. In general, the UE 104 may perform UL Tx switching by switching from one UL transmit case to another UL transmit case. In operation, the UE 104 may transmit a UL transmission according to a first UL transmit case, and then may switch from the first UL transmit case to a second UL transmit case, and transmit a UL transmission according to the second UL transmit case. In addition, in various embodiments, UL transmit cases may also identify numbers of antenna ports corresponding to the carriers. The identification may be in the form of a mapping between carriers and respective numbers of antenna ports. For at least some of these embodiments, the numbers of antennas may depend on whether or not the UE 104 supports simultaneous transmission across a band pair.

### Tx Switching

FIG. 4 shows a block diagram illustrating relationships between carriers, bands, and cells. Two bands can be configured for UE to do Tx switching. The following describes various embodiments related to sharing UE capability among the cells/carriers/bands among three or four bands in some embodiments.

For a UE, an RF transceiver including LNAs (Low Noise Amplifiers), mixer, and local oscillator may be about half the cost for the RF part, with a RF-to-baseband cost ratio of 40:60 or 50:50 for a UE. The RF transceiver may include a receive RF chain, a transmitter (UL Tx), or other common parts. If the number of RF chains can be reduced from two received RF chains to a single received RF chain, the cost can be reduced by up to 50%. Since the transmitter and common parts (e.g., frequency synthesis) cannot be removed, the cost reduction of the whole RF transceiver may be considerably reduced.

In this Tx switching embodiment, received radio frequency (RF) chains may be shared for improved UE performance. There may be 1, 2, or 4 receivers (Rx) or antenna. Antenna may refer to any receiver including covering “received RF chains.” The antenna may be supported for a band, but if there are two bands from different frequencies (e.g. one from sub-1 GHz spectrum, the other from 2 GHz spectrum), the Rx for each of those bands needs to be shared to reduce the UE cost and keep the similar performance.

When the UE has the UE capability to support at least one antenna to be used for at least two bands, the UE reports Rx sharing or Rx switching between two bands or among multiple bands is supported for a band combination. In order to support this Rx sharing or Rx switching, the following embodiments may be utilized. To achieve antenna sharing or switching, there may be a few embodiments: 1) a first embodiment, use the antenna on one band for another band together with its original antenna; or 2) a second embodiment, the same antennas for a set of bands are switched between two bands.

In the first embodiment, the UE can support at least one antenna on the active band (e.g. 2 Rx per band). For example, assuming a band combination including two bands, there may be one in 2Rx per band and 4Rx may be achieved by using all the antennas on two bands for only one band. As a result, there may be a UE capability to support at least one antenna on one band in a set of bands that can be shared for another band in the set of bands. When at least one antenna to be used for at least two bands, downlink (DL) Rx switching can be applied. The benefit is to reduce UE cost or enhance transceiver capability. For example, 2Rx per band and 4Rx can be achieved by using all the antennas on two bands for only one band. When the UE is to transmit a 4-port transmission on one downlink carrier on one band and if the Rx chain state at the preceding downlink transmission is 1-port or 2-port transmission on another downlink carrier on another band, the UE may not be expected to transmit for a duration on any of the carriers. As a result, there may be a UE capability to report a duration applied for at least one antenna on one band in a set of bands shared and used for another band in the set of bands.

In the second embodiment, the UE can support at least one antenna for a set of bands for shared use rather than per band. The antenna is shared use for at least one band (e.g. 2 Rx for 2 bands). For example, there is only 2Rx for two bands, and 2Rx per band can be achieved by switching. As a result, there may be a UE capability to support at least one antenna for a set of bands that can be shared and used for at least one band of the set of bands. If there are only 2Rx for two bands, then 2Rx per band can be achieved by switching. When the UE is to transmit a 2-port transmission on one downlink carrier on one band and if Rx chain state at the preceding downlink transmission is 1-port or 2-port transmission on another downlink carrier on another band, the UE is not expected to transmit for a duration on any of the carriers. As a result, there may be a UE capability to report a duration applied for at least one antenna for a set of bands shared for at least one band of the set of bands.

In some embodiments, when a UE is triggered to perform Rx sharing or switching between a band pair, and the start of the DL transmission after Rx switching is T0, UE uses DCIs received before T0-Toffset to determine how to perform switching, where Toffset is the UE processing procedure time defined for the downlink transmission triggering the switch, such as physical downlink shared channel (PDSCH) processing procedure time.

In this Tx switching embodiment, when multi-carrier on multi-bands is supported by a UE, the Rx can be shared by using an antenna on one band for another band together with its original antenna. Alternatively, the same antenna for a set of bands is switched between two bands with a corresponding UE capability. The UE capability will not be wasted if one carrier or one band is not working at a time or within a specific period/duration.

### Power Amplifier (PA) Sharing/Switching

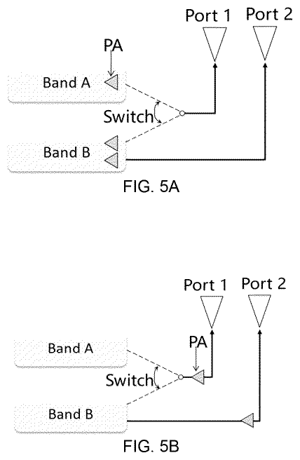

For a UE, the power amplifier (PA) may be about 30% cost of RF. The RF-to-baseband cost ratio may be 40:60 or 50:50 for a UE. Removal of the power amplifier (PA) may result in about 10% overall relative cost saving. As described in this embodiment, the PA can be shared for improved performance. For a band combination with one Frequency Division Duplex (FDD) band and one Time Division Duplex (TDD) band, the UE may have 3 independent PAs implemented in the Radio Frequency Front End (RFFE). FIG. 5A shows an embodiment of transmitter (Tx) switching without power amplifier (PA) switching. FIG. 5A shows Tx switching where the UE has up to 2 Tx and 3 PAs.

The Tx RF architecture may have an assumption for handheld UE with 2 concurrent Tx chains. This may lead to the situation that UE works with 2PAs in a single high frequency band, but when it is configured with a CA/EN-DC (E-UTRA-NR Dual Connectivity) band combination, then only one PA is activated in each band (one mid/high band PA is not activated), so that one of the three PAs is not working simultaneously with the other two PAs. In one example, there may be two PA on TDD band with 2Tx chains are used for 2-port UL transmission on a TDD carrier. In a second example, there may be one PA on FDD band and one PA on TDD band with 1-port UL transmission on a FDD carrier on FDD band+1-port UL transmission on a TDD carrier on TDD band. Without support for UL Tx (transmitter) switching, only one of these two examples could be supported. With UL Tx switching support, both example 1 and example 2 can be supported with 1Tx switched between the two bands. As shown in FIG. 5A, when 1Tx is switched to band A, then example 2 is supported; and when 1Tx is switched to band B, then example 1 is supported. Accordingly, there may be one PA not working together with the other two PAs.

FIG. 5B shows an embodiment of transmitter (Tx) switching with power amplifier (PA) switching. In order to achieve UE cost reduction with comparable performance, PA sharing or switching is supported. In some embodiments, this may be combined with UL Tx switching. When there is a UE with a capability to support at least one PA for at least two bands, then the UE reports PA sharing or PA switching between two bands or among multiple bands is supported for a band combination.

Since the function or capability of PA for different bands may be different, the PA shared or switched between two bands or among multiple bands may be the PA of the band with highest capability of the two or multiple bands. When at least one PA is used for at least two bands, PA switching can be utilized. The benefit may be to reduce UE cost with the same performance.

In some embodiments, PA switching may be supported with UL Tx switching when a duration applied for PA switching combined with Tx switching can be reported independently. For example, it may report a value comprising or considering both the duration for PA switching and for UL Tx switching. In another example, based on a legacy duration of UL Tx switching, there may be a report of an additional value comprising the duration for PA switching, then the UL Tx switching gap will be determined by a summation of the two durations. When the UE is to transmit a 2-port transmission on one uplink carrier on one band and if the preceding uplink transmission is a 1-port transmission on another uplink carrier on another band, then the UE is not expected to transmit for a duration on any of the carriers. The duration may be for UL Tx switching, or the duration is for UL Tx switching and PA switching. Determining which duration may be based on a UE report or basestation configuration/indication. If the duration is determined by UE report, the UE will only report one value for a band pair within several candidate values comprising different cases, such as UL Tx switching without PA switching, UL Tx switching with PA switching, etc. If the duration is determined by basestation configuration, the UE may report multiple values for a band pair within several candidate values comprising different cases, such as UL Tx switching without PA switching, UL Tx switching with PA switching, etc. Then the basestation may configure one value for the duration.

In some embodiments, when a UE is triggered to perform Tx sharing or switching between a band pair, and the start of the UL transmission after Tx switching is T0, the UE uses DCIs received before T0-Toffset to determine how to perform switching. In this example, Toffset is the UE processing procedure time defined for the downlink transmission triggering the switch, such as the PUSCH preparation procedure time.

In some embodiments, when two bands are both FDD bands and with one PA in one each band, or in case two bands are FDD band+TDD band with 3PA in total, then higher power or higher power class (PC) can be supported by PA sharing or switching for one band. For example, band 1 is FDD band with PC3=23 dBm, band 2 is FDD band with PC3=23 dBm, with support of PA sharing or switching, then 2PA are used for one FDD band, PC2=26 dBm can be supported for the FDD band. The maximum duty cycle may be reported and applied for the PC2 case. In another example, band 1 is FDD band with PC3=23 dBm, band 2 is TDD band with PC2=26 dBm, with support of PA sharing or switching, then 3PA may be used for the TDD band, power class with 27.8 dBm can be supported for the TDD band. The maximum duty cycle may be reported and applied for the higher power case.

In the PA sharing embodiment, when multi-carrier on multi-bands are supported by a UE, the PA can be shared by combining with UL Tx switching between two bands with corresponding UE capability. The UE capability may not be wasted if one layer or one carrier or one band is not working at a time or within a period/duration.

### Duplexer Sharing/Switching

For a UE, a duplexer or switch may be about 15% cost of RF, and the RF-to-baseband cost ratio may be 40:60 or 50:50 for a UE. The duplexer used for Frequency Division Duplex (FDD) may exist on the antenna that is driven by the UE transmitter. Time Division Duplex (TDD) and Half Duplex (HD) FDD (HD-FDD) may not require a duplexer and a switch may be used instead of a duplexer. The potential relative cost may be even larger for multi-band devices that may have multiple duplexers than for a single-band reference modem.

There may be multiple embodiments, including a first embodiment with a single band, and a second embodiment with multiple bands. In order to use the duplexer more efficiently, duplexer sharing within single band for sub-band full duplex (SBFD) or multiple bands is supported with a corresponding UE capability that is shared. For SBFD in a TDD carrier that is supported by the basestation, the UE may still perform as TDD or HD-FDD, and the UE may have no need for a duplexer.

In the first embodiment where SBFD in a TDD carrier is supported by the UE, one duplexer may be shared used between SBFD symbols and non-SBFD symbols. For example, in the time duration of sub-band part or SBFD symbols, the duplexer may be used as FDD for DL sub-band and UL sub-band. In the other time duration part or non-SBFD symbols, the duplexer may be used as a switch for legacy TDD for D/U switch.

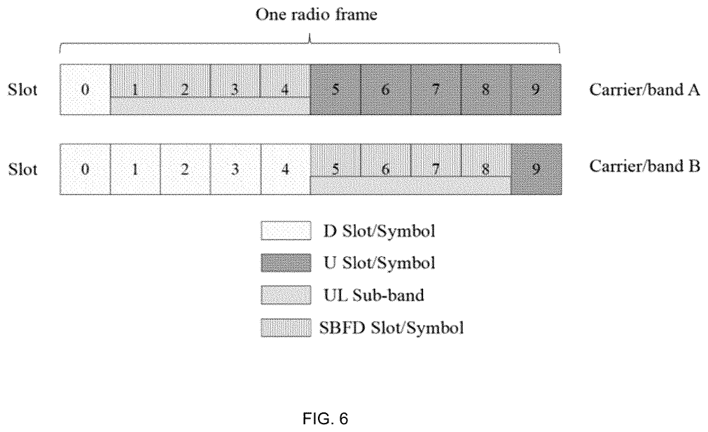

In the second embodiment where multiple bands for inter-band CA, with one or more bands with SBFD configured/supported, the duplexer sharing among bands is supported with the corresponding UE capability. FIG. 6 shows an embodiment of sub-band full duplex (SBFD) on two bands. This may include complementary SBFD on two bands where one duplexer is shared use. For example, for complementary SBFD with the SBFD symbols or a duration configured with UL sub-band in one carrier on one band, is not overlapped in time domain with the SBFD symbols or a duration configured with UL sub-band in another carrier on another band, there may be a switch for each TDD carrier/band, and one duplexer is sharing the SBFD symbols duration between the two bands with complementary SBFD symbols on the two bands.

In the duplexer sharing embodiment, when one carrier on one band with SBFD or multi-carrier on multi-bands are supported by a UE, the duplexer can be shared between sub-bands or multiple bands with a corresponding UE capability. The UE capability may not be wasted if one layer or one carrier or one band is not working at a time or within a period/duration.

### PDCCH Monitoring Sharing

The prior embodiment includes RF parts, while the next two embodiments (PDCCH Monitoring Sharing and PUSCH Processing Sharing) include baseband parts. For a UE, downlink (DL) control processing and decoding may be about 5% cost of a baseband part. The RF-to-baseband cost ratio may be 40:60 or 50:50 for a UE. The DL control processing and decoding may include Physical Downlink Control Channel (PDCCH) candidates monitoring and decoding. PDCCH monitoring capability may be restricted per carrier or cell without CA scaling, or may be further combined with a restriction of per sub-carrier spacing with CA scaling. With more carriers configured/supported, the cost of DL control processing and decoding may be even larger for multi-carrier or multi-band devices than for the single-carrier or single-band reference modem.

In order to use DL control processing and decoding more efficiently, Physical Downlink Control Channel (PDCCH) monitoring capability sharing within multiple carriers/cells/bands is supported with a corresponding UE capability.

Without CA scaling, the PDCCH monitoring capability may restricted by Blind Decode/Control Channel Element (BD/CCE) budget per carrier/cell. The maximum number

$${M}_{PDCCH}^{m ax , slot , μ}$$

of monitored PDCCH candidates per slot for a DL BWP with SCS configuration μ∈{0, 1, 2, 3} for a single serving cell is shown in Table 1, and the Maximum number

$${C}_{PDCCH}^{m ax , slot , μ}$$

of non-overlapped CCEs per slot for a DL BWP with SCS configuration μ∈{0, 1, 2, 3} for a single serving cell is shown in Table 2, where μ∈{0, 1, 2, 3} is corresponding to 15 khz, 30 khz, 60 khz and 120 khz, respectively.

TABLE 1
Max blind decode (BD) per slot per cell

| | Maximum number of monitored PDCCH |
|---|---|
| | candidates per slot and per serving cell |
| μ | ${M}_{PDCCH}^{m ax , slot , μ}$ |
| 0 | 44 |
| 1 | 36 |
| 2 | 22 |
| 3 | 20 |

TABLE 2
Max non-overlapped Control Channel Element (CCE) per slot per cell
With CA scaling, PDCCH monitoring capability may be
restricted by BD/CCE

| | Maximum number of non-overlapped |
|---|---|
| μ | $CCEs per slot and per serving cell {C}_{PDCCH}^{m ax , slot , μ}$ |
| 0 | 56 |
| 1 | 56 |
| 2 | 48 |
| 3 | 32 |

budget per carrier/cell and per sub-carrier spacing (SCS). If a UE is configured with

$${N}_{cells}^{DL , μ}$$

downlink cells with DL BWPs having SCS configuration μ, where

$${\sum }_{μ = 0}^{3} {N}_{cells}^{DL , μ} > {N}_{cells}^{cap} ,$$

a DL bandwidth part (BWP) of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , slot , μ} = ⌊ {N}_{cells}^{cap} \cdot {M}_{PDCCH}^{ma x , slot , μ} \cdot {N}_{cells}^{DL , μ} / {\sum }_{j = 0}^{3} {N}_{cells}^{DL , j} ⌋$$

PDCCH candidates or more than

$${C}_{PDCCH}^{total , slot , μ} = ⌊ {N}_{cells}^{cap} \cdot {C}_{PDCCH}^{ma x , slot , μ} \cdot {N}_{cells}^{DL , μ} / {\sum }_{j = 0}^{3} {N}_{cells}^{DL , j} ⌋$$

non-overlapped CCEs per slot on the active DL BWP(s) of scheduling cell(s) from the

$${N}_{cells}^{DL , μ}$$

downlink cells, where

$${N}_{cells}^{cap}$$

is the UE reported value.

There may be a DCI size budget for a UE per serving cell. The UE is not expected to handle the total number of different DCI sizes configured to monitor more than 4 for the cell; or the total number of different DCI sizes with C-RNTI configured to monitor is more than 3 for the cell.

There may be three embodiments (described below) for how to use PDCCH monitoring capability sharing with multiple carriers. PDCCH monitoring capability sharing within multiple carriers may be supported by at least one of following embodiments: 1) a first embodiment, BD/CCE sharing within more than one scheduling cell for one scheduled cell, when the scheduled cell is configured with more than one scheduling cell; 2) a second embodiment, BD/CCE sharing within one scheduling cells for more than one scheduled cell regardless of the restriction per cell, when the more than one scheduled cell are configured with the same scheduling cell; and 3) a third embodiment, BD/CCE sharing within more than one carriers/cells regardless of whether the cell is configured as scheduling cell or scheduled cell.

In a first embodiment, BD/CCE sharing within more than one scheduling cell for one scheduled cell when the scheduled cell is configured with more than one scheduling cell. With a UE capability, a soft split within the multiple scheduling cells for the same scheduled cell is supported. Optionally, if the total BD/CCE is determined by one of the multiple scheduling cells, the budget of BD/CCE for the soft split will be used per slot of the scheduling cell with sharing for each scheduling cell. For example, if the scheduled cell is configured with three scheduling cells with SCS=15 khz, 30 khz, 30 khz, and the total BD/CCE is determined by one scheduling cell with SCS=30 khz, that is 36 BDs per 30 Khz slot, and can be shared used within three scheduling cells for the scheduled cell with a not larger than the total BD/CCE after summation of the candidates from all scheduling cells. Regardless of whether one or two scheduling cells are deactivated or dormant, the total BD/CCE for the scheduled cell can be used by at least one scheduling cell.

Optionally, if the total BD/CCE is determined by more than one of the multiple scheduling cells by a function of more than one scheduling cell, such as weight average of each scheduling cell with different SCS, the budget of BD/CCE for a soft split may be used per slot of one scheduling cell having smallest SCS with sharing for each scheduling cell. For example, if the scheduled cell is configured with three scheduling cells with SCS=15 khz, 30 khz, 30 khz, and the total BD/CCE is determined by two scheduling cells with SCS=15 khz, 30 khz with weights=0.5, 0.5 (respectively), then (0.5*44+0.5*36*2)=58 BDs per 15 Khz slot. It can be shared and used within three scheduling cells for the scheduled cell with not larger than the total BD/CCE after summation of the candidates from all scheduling cells. Regardless of whether one or two scheduling cells are deactivated or dormant, the total BD/CCE for the scheduled cell can be used by at least one scheduling cell.

In a second embodiment, BD/CCE sharing may be within one scheduling cell for more than one scheduled cell regardless of the restriction per cell when the more than one scheduled cell are configured with the same scheduling cell. With a UE capability, a soft split within the multiple scheduled cells for the same scheduling cell is supported. For example, if 3 scheduled cells are configured with the same scheduling cell with SCS=30 khz and the total BD/CCE is determined by three times of scheduling cell with SCS=30 khz, that is 3*36=108 BDs per 30 Khz slot, then it can be shared for three scheduled cells for the schedule cell with a not larger than the total BD/CCE after summation of the candidates from all scheduled cells. Regardless of whether one or two scheduled cells are deactivated or dormant, the total BD/CCE for all the three scheduled cells can be used for at least one scheduled cell. For example, if two of the three carriers/cells are deactivated or dormant, the BD/CCE for the third cell can be up to 108 BDs in this example.

In a third embodiment, BD/CCE sharing is within more than one carrier/cell regardless of whether the cell is configured as a scheduling cell or a scheduled cell. With a UE capability, a soft split within the multiple cells is supported. For example, if K cells are configured for a UE, K=1, 2, 3, 4, . . . , without CA scaling, and with the same SCS for the cells, the total BD/CCE for multi-cell is defined as K*Mmax, without the restriction of Mmax per cell. Optionally, there may be more than one threshold for candidate dropping on PCell with BD/CCE sharing. One threshold may be used as legacy without BD/CCE sharing supported, while the other threshold(s) is/are used with BD/CCE sharing supported when there is no need to monitor PDCCH for at least one SCell. When at least one SCell is deactivated or dormant, or having no monitoring occasion in one slot or span, the threshold for candidate dropping for the PCell is larger than the legacy BD/CCE budget per PCell. For example, PCell and one SCell are configured/reported to support BD/CCE sharing, including up to N1 BD/CCEs for PCell and up to N2 BD/CCE for SCell. Up to N1+N2 BD/CCEs can shared and used for both cells. In a slot, both PCell and SCell are needed to be performed with PDCCH monitoring by the UE, the threshold for candidate dropping on PCell is N1, while in another slot only PCell is needed to be performed with PDCCH monitoring by the UE, the threshold for candidate dropping on PCell is N1+N2. The candidates dropping is performed based on UE specific search space (USS) level or candidates level, based on USS or candidate index to drop with descending order, or based on USS or candidate index to monitor the PDCCH candidates with ascending order.

In the PDCCH Monitoring Sharing embodiment, when multiple carriers/cells/bands are supported by a UE, the control channel monitoring capability can be shared within multiple carriers/cells/bands with the corresponding UE capability. The UE capability will not be wasted if one layer or one carrier or one band is not working at a time or within a period/duration.

### PUSCH Processing Sharing

For a UE, an uplink (UL) processing block may be about 5%-10% cost of the baseband part, and the RF-to-baseband cost ratio may be 40:60 or 50:50 for a UE. The UL processing block may be for PUSCH processing in some embodiments. PUSCH processing may be restricted per slot/sub-slot per carrier/cell. For any HARQ process ID(s) in a given scheduled cell, the UE may not be expected to transmit a PUSCH that overlaps in time with another PUSCH. With more carriers/cells configured/supported, the cost of UL processing block may be even larger for multi-carrier or multi-band devices than for the assumed single-carrier or single-band reference modem. In order to use the UL processing block more efficiently, UL channel processing capability may be shared within multiple carriers/cells/bands as part of a corresponding UE capability.

In some embodiments, when CA is supported/configured for a UE, at least two PUSCHs, Frequency Division Multiplexed (FDMed) on one carrier/cell/band is supported with a UE capability. For example, a 2Tx UE with CA supported/configured and each carrier on one band within a band pair or band combination, two FDMed PUSCHs which is overlapped in time domain and non-overlapped in frequency domain, each PUSCH with 1Tx can be supported by sharing the CA capability of PUSCH 1Tx on band A+PUSCH 1Tx on band B transmitted simultaneously.

In some embodiments, for the two FDMed PUSCHs, it may be scheduled by two DCIs or one DCI. For the two DCIs scheduling, each PUSCH may be independently scheduled by one DCI with continuous frequency domain resource allocation and with additional UE capabilities of baseband and RF to support the FDMed PUSCH transmission. For the one DCI scheduling, each PUSCH may be determined by one cluster within two-cluster frequency domain resource allocation, or by one of two fields of frequency domain resource allocation. Optionally, there may be two time domain resource allocations for each PUSCH within a joint TDRA table.

In some embodiments, the processing X unicast DCIs scheduling UL per scheduling CC (Component Carrier) slot per scheduled CC for F/TDD scheduling CC is supported, when the sharing UL channel processing capability is supported. X is larger than the value for one carrier without support the sharing UL channel processing capability.

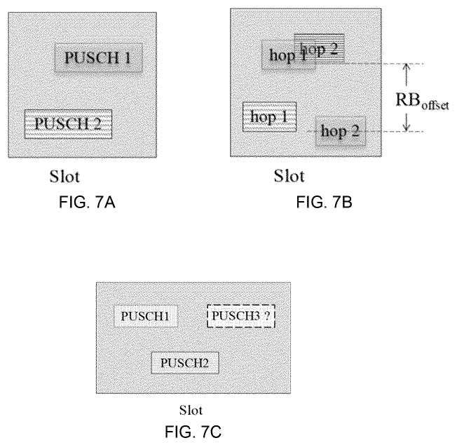

In some embodiments, at least based on one DCI scheduling case. When two FDMed PUSCH are partial overlapped in time domain, this is no collision without hopping as shown in FIG. 7A. In order to avoid a hopping collision as shown in FIG. 7B, frequency hopping may be supported by independent/joint indication of frequency hopping for each cluster/PUSCH in a single DCI, optionally combined with independent RB_offset list configured for the second cluster/PUSCH or for each cluster/PUSCH. FIG. 7A shows an embodiment for FDMed Physical Uplink Shared Channel (PUSCH) without frequency hopping. FIG. 7B shows an embodiment for FDMed PUSCH with frequency hopping. The hopping collision is shown in FIG. 7B.

In some embodiments, the UE is not expected to transmit a third PUSCH/PUCCH that overlaps in time with a second PUSCH which is already overlapped with a first PUSCH. As shown in FIG. 7A, PUSCH 3 is not expected to be scheduled/transmitted. In some embodiments, regardless the number of overlapped PUSCHs in time and/or frequency domain, with the sharing UL channel processing capability supported by a UE, each 1Tx can be used for one PUSCH processing line. If one PUSCH overlapped with two TDMed PUSCHs, the three PUSCHs can be processed by the UE. As shown in FIG. 7C, PUSCH 3 can be scheduled/transmitted. FIG. 7C shows an embodiment of a slot with more than one overlapped Physical Uplink Shared Channel (PUSCH). More than two PUSCHs are overlapped which is different from FIG. 7A.

In some embodiments, the maximum number of PUSCHs in one slot/sub-slot is X with FDMed PUSCH transmitted capability supported. The maximum number of PUSCHs in one slot is Y with TDMed PUSCH transmitted capability supported. The maximum number of PUSCHs in one slot is Z with both FDMed and TDMed PUSCH transmitted capability supported, wherein Z is an integer, and may be no less than X, Y, or X+Y, or no larger than X, Y, or X*Y.

In some embodiments, PUSCH may be used for above example, or it may be replaced by PUCCH.

In some embodiments, when FDMed PUSCH and PUCCH are supported by a UE with a corresponding UE capability, PUSCH and PUCCH can be transmitted simultaneously on a carrier by a UE. Optionally, when UE reports support, PUSCH and PUCCH can be transmitted simultaneously, and the basestation could configure example 1 or example 2 by a RRC parameter, wherein example 1 is PUSCH and PUCCH being transmitted simultaneously, and example 2 is UCI multiplexing with PUSCH with the restriction that PUCCH and PUSCH cannot be transmitted simultaneously on a carrier. When the basestation configured example 1, PUCCH can be transmitted simultaneously with PUSCH, regardless of single transmission or repetition. When basestation configured example 2, PUCCH cannot be transmitted simultaneously with PUSCH, and the UCI will be multiplexed on PUSCH.

Optionally, when UE reports to support, PUSCH and PUCCH can be transmitted simultaneously, basestation could configure both example 1 and example 2 by a RRC parameter, where example 1 is PUSCH and PUCCH can be transmitted simultaneously, and example 2 is UCI multiplexing with PUSCH. Further whether using example 1 or example 2 can be indicated by DCI, for a scenario of PUCCH overlapped with PUSCH repetition. When one PUCCH is overlapped with one repetition of a PUSCH repetition, UCI multiplexing may be used, while another PUCCH is overlapped with another repetition of the PUSCH repetition, PUCCH and PUSCH transmitted may simultaneously be used. The example 1 or example 2 indication may be included in the DL DCI at least used for indicating the PUCCH resource, or in the UL DCI at least used for indicating the PUSCH transmission.

In the PUSCH Processing Sharing embodiment, when multiple r carriers/cells/bands are supported by a UE, the UL channel processing capability can be shared within multiple carriers/cells/bands with a corresponding UE capability. The UE capability may not be wasted if one layer or one carrier or one band is not working at a time or within a period/duration.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software-based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for wireless communication comprising:
reporting, by a user equipment (UE), a UE capability; and
supporting, by the UE, a function sharing based on the reported UE capability, wherein the function sharing is supported within one or more carriers, cells, or bands.

2. The method of claim 1, wherein the function sharing supports at least one antenna for at least two bands.

3. The method of claim 2, wherein the at least one antenna on one band in a set of bands can be used for another band in the set of bands.

4. The method of claim 2, wherein the at least one antenna for a set of bands can be used for at least one band of the set of bands.

5. The method of claim 1, wherein the function sharing supports at least one power amplifier (PA) for at least two bands.

6. The method of claim 5, wherein when the at least one PA is shared between multiple bands, wherein the at least one PA of the band with a highest capability of the bands is used.

7. The method of claim 5, further comprising:
reporting a duration for PA switching combined with transmitter (Tx) switching, wherein the duration is applied for both PA switching and Tx switching, or the duration is an additional duration applied for PA switching.

8. The method of claim 5, wherein a higher power or a higher power class can be supported by PA sharing or switching for a band within a band pair or band combination.

9. The method of claim 1, wherein the function sharing supports duplexer enhancement within a single band or within multiple bands.

10. The method of claim 9, wherein the duplexer enhancement within the single band comprises sharing a duplexer between SBFD and non-SBFD symbols for a carrier with sub-band full duplex (SBFD) supported on the single band.

11. The method of claim 9, wherein the duplexer enhancement within the multiple bands comprises sharing a duplexer for the duration of the SBFD symbols of the multiple bands, wherein the SBFD symbols on multiple bands are non-overlapped and the sharing is for at least two carriers with SBFD supported on the multiple bands.

12. The method of claim 1, wherein the function sharing supports a Physical Downlink Control Channel (PDCCH) monitoring capability enhancement within multiple cells, wherein the PDCCH monitoring capability enhancement comprises sharing PDCCH candidates blind decode (BD) or non-overlapped control channel element (CCE).

13. The method of claim 12, wherein more than one threshold is applied for candidates dropping on primary cell (PCell).

14. The method of claim 13, wherein one threshold from the more than a first threshold is used in a slot when there is no sharing BD/CCE from other cells, and the second threshold from the more than one threshold is used in a slot when sharing of BD/CCE is applied from other cells.

15. The method of claim 14, the second threshold is applied when there is no need to monitor PDCCH for at least one secondary cell (SCell).

16. The method of claim 1, wherein the function sharing supports an uplink (UL) channel processing capability enhancement, wherein at least two Physical Uplink Shared Channel (PUSCH) being overlapped in time domain on a single carrier is supported, or PUSCH and Physical Uplink Control Channel (PUCCH) being overlapped in time domain on a single carrier is supported.

17. The method of claim 16, further comprising at least one of following:
providing, by a wireless communication node, an indication of frequency hopping for each PUSCH in a Downlink Control Information (DCI); and
providing, by the wireless communication node, an independent resource block (RB) offset list for the overlapped PUSCH.

18. The method of claim 16, wherein one of two transmission schemes is used by a DCI indication, the two transmission schemes comprising uplink control information (UCI) multiplexed on PUSCH, and PUCCH transmitted with PUSCH simultaneously.

19. A wireless communications apparatus comprising a processor and a memory, wherein the processor is configured to read code from the memory and execute steps of:
reporting a user equipment (UE) capability; and
supporting a function sharing based on the reported UE capability, wherein the function sharing is supported within one or more carriers, cells, or bands.

20. A computer program product comprising a computer-readable program medium code stored thereupon, the code, when executed by a processor, causing the processor to execute steps of:
reporting a user equipment (UE) capability; and
supporting a function sharing based on the reported UE capability, wherein the function sharing is supported within one or more carriers, cells, or bands.
